(19) United States
(12) Patent Application Publication
(10) Pub. No.: US 2025/0233211 A1
(43) Pub. Date: Jul. 17, 2025

(54) ALL-SOLID-STATE BATTERY

(71) Applicant: SAMSUNG ELECTRO-MECHANICS CO., LTD., Suwon-si, Gyeonggi-do (KR)

(72) Inventors: Youngjin Hwang, Suwon-si, Gyeonggi-do (KR); Han Kim, Suwon-si, Gyeonggi-do (KR)

(73) Assignee: SAMSUNG ELECTRO-MECHANICS CO., LTD., Suwon-si, Gyeonggi-do (KR)

(21) Appl. No.: 18/569,540

(22) PCT Filed: Oct. 25, 2023
(86) PCT No.: PCT/KR2023/016644

§ 371 Date: Dec. 12, 2023

(30) Foreign Application Priority Data
Jul. 13, 2023 (KR) 10-2023-0090942

(51) Int. Cl. H01M 10/0585; H01M 10/0525

(52) U.S. Cl. CPC H01M 10/0585; H01M 10/0525; H01M 2300/0068

(57) ABSTRACT

A disclosed all-solid-state battery may include a laminate that has a first surface and a second surface facing each other in a first direction, a third surface and a fourth surface face each other in a second direction and coupling the first surface and the second surface, and a fifth surface and a sixth surface facing each other in a third direction and coupling the first surface and the second surface, and includes solid electrolyte layers, and anode layers and cathode layers that are alternately stacked in the third direction with the solid electrolyte layers interposed therebetween, and a margin member that is disposed on the third surface, the fourth surface, the fifth surface, and the sixth surface of the laminate.

### CROSS-REFERENCE TO RELATED APPLICATION

This application claims priority to and the benefit of Korean Patent Application No. 10-2023-0090942 filed in the Korean Intellectual Property Office on Jul. 13, 2023, the entire contents of which are incorporated herein by reference.

### TECHNICAL FIELD

The present disclosure relates to an all-solid-state battery.

### BACKGROUND ART

In recent years, as portable electronic devices have been required to be minimized and be usable for a long time, it has been required to increase the capacity of batteries, and with the spread of wearable electronic devices, it has been required to secure safety of batteries.

Since lithium-ion batteries currently on the market include liquid electrolytes containing flammable organic solvents, there is a possibility of overheating and fire in the event of a short circuit. For this reason, all-solid-state batteries using solid electrolytes in place of liquid electrolytes have been proposed.

All-solid-state batteries do not use flammable organic solvents, whereby it is possible to significantly reduce the possibility of fire or explosion even in the event of a short circuit. Accordingly, such all-solid-state batteries can greatly improve safety as compared to lithium-ion batteries using liquid electrolytes.

An all-solid-state battery gets better as the energy density gets higher, i.e., as the product of the capacity and the voltage (Wh=Ah*V) increases when the volume is constant. Therefore, a technology capable of improving the capacity of all-solid-state batteries while keeping their volumes constant is required.

### DISCLOSURE OF INVENTION

### Technical Problem

An aspect of embodiments attempts to provide an all-solid-state battery capable of increasing capability while keeping volume constant.

However, objects which the embodiments of the present disclosure attempt to achieve are not limited to the above-mentioned object, and can be variously expanded without the technical spirit and scope of the present disclosure.

### Solution to Problem

An all-solid-state battery according to an embodiment may include a laminate that has a first surface and a second surface facing each other in a first direction, a third surface and a fourth surface face each other in a second direction and coupling the first surface and the second surface, and a fifth surface and a sixth surface facing each other in a third direction and coupling the first surface and the second surface, and includes solid electrolyte layers, and anode layers and cathode layers that are alternately stacked in the third direction with the solid electrolyte layers interposed therebetween, and a margin member that is disposed on the third surface, the fourth surface, the fifth surface, and the sixth surface of the laminate.

Further, the margin member may comprise an insulating material.

Furthermore, the solid electrolyte layers, the anode layers, and the cathode layers may abut the margin member on the third surface and the fourth surface of the laminate.

Also, the all-solid-state battery may further include a first external electrode that is coupled to the anode layers on the first surface of the laminate, and a second external electrode that is coupled to the cathode layers on the second surface of the laminate.

Also, the all-solid-state battery may further include first insulators that are disposed between the second surface of the laminate and the anode layers, and second insulators that are disposed between the first surface of the laminate and the cathode layers.

Further, the first insulators may abut the solid electrolyte layers, and the second insulators may abut the solid electrolyte layers.

Furthermore, the first insulators and the second insulators may comprise the same material as that of the margin member.

Moreover, the first insulators and the second insulators may comprise a material different from that of the margin member.

Further, the first external electrode may extend to the third surface, the fourth surface, the fifth surface, and the sixth surface of the laminate so as to partially cover the margin member, and the second external electrode may extend to the third surface, the fourth surface, the fifth surface, and the sixth surface of the laminate so as to partially cover the margin member.

Alternatively, the first external electrode may extend to the fifth surface of the laminate so as to partially cover the margin member, and the second external electrode may extend to the fifth surface of the laminate so as to partially cover the margin member.

Furthermore, the anode layers may include anode current collectors and an anode active material, and the cathode layers may include cathode current collectors and a cathode active material.

### Advantageous Effects of Invention

According to the all-solid-state battery according to the embodiment, it is possible to increase capacity while keeping volume constant.

### BRIEF DESCRIPTION OF DRAWINGS

FIG. 1 is a perspective view schematically illustrating an all-solid-state battery according to an embodiment.

FIG. 2 is a perspective view schematically illustrating the main body of the all-solid-state battery of FIG. 1.

FIG. 3 is a perspective view schematically illustrating a laminate of the all-solid-state battery of FIG. 1.

FIG. 4 is a schematic cross-sectional view taken along line IV-IV′ in FIG. 1.

FIGS. 5A to 5G are views schematically illustrating a method of manufacturing the all-solid-state battery according to the embodiment.

FIG. 6 is a view schematically illustrating a laminate manufactured according to a comparative example.

FIG. 7 is a width-wise (W-axis direction) and thickness-wise (T-axis direction) cross section of the all-solid-state battery, manufactured according to the embodiment, at the center in the length-wise (L-axis direction).

FIG. 8 is a width-wise (W-axis direction) and thickness-wise (T-axis direction) cross section of the all-solid-state battery, manufactured according to the comparative example, at the center in the length-wise (L-axis direction).

### MODE FOR THE INVENTION

Hereinafter, embodiments of the present disclosure will be described in detail with reference to the accompanying drawings such that those skilled in the art can easily implement them. The drawings and description are to be regarded as illustrative in nature and not restrictive. Like reference numerals designate like elements throughout the specification. Further, some constituent elements in the drawing may be exaggerated, omitted, or schematically illustrated, and a size of each constituent element does not reflect the actual size entirely.

The accompanying drawings are provided for helping to easily understand embodiments disclosed in the present specification, and the technical spirit disclosed in the present specification is not limited by the accompanying drawings, and it will be appreciated that the present disclosure includes all of the modifications, equivalent matters, and substitutes included in the spirit and the technical scope of the present disclosure.

Terms including an ordinary number, such as first and second, are used for describing various constituent elements, but the constituent elements are not limited by the terms. The terms are used only to discriminate one constituent element from another constituent element.

Further, it will be understood that when an element such as a layer, film, region, or substrate is referred to as being “on” another element, it can be directly on the other element or intervening elements may also be present. In contrast, when an element is referred to as being “directly on” another element, there are no intervening elements present. Further, when an element is “on” a reference portion, the element is located above or below the reference portion, and it does not necessarily mean that the element is located “above” or “on” in a direction opposite to gravity.

In the present application, it will be appreciated that terms “including” and “having” are intended to designate the existence of characteristics, numbers, steps, operations, constituent elements, and components described in the specification or a combination thereof, and do not exclude a possibility of the existence or addition of one or more other characteristics, numbers, steps, operations, constituent elements, and components, or a combination thereof in advance. Therefore, unless explicitly described to the contrary, the word “comprise”, and variations such as “comprises” or “comprising”, will be understood to imply the inclusion of stated elements but not the exclusion of any other elements.

Further, in the entire specification, when it is referred to as “on a plane”, it means when a target part is viewed from above, and when it is referred to as “on a cross section”, it means when the cross section obtained by cutting a target part vertically is viewed from the side.

Further, throughout the specification, when it is referred to as “connected”, this does not only mean that two or more constituent elements are directly connected, but may mean that two or more constituent elements are indirectly connected through another constituent element, are physically connected, electrically connected, or are integrated even though two or more constituent elements are referred as different names depending on a location and a function.

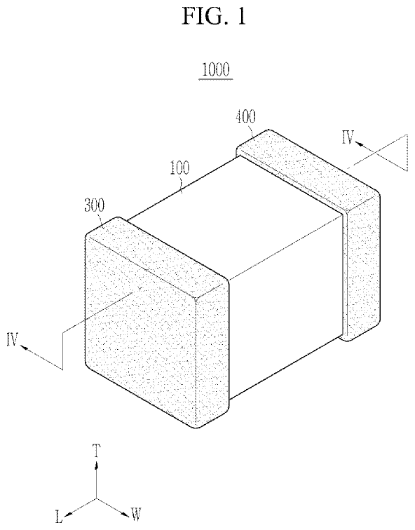

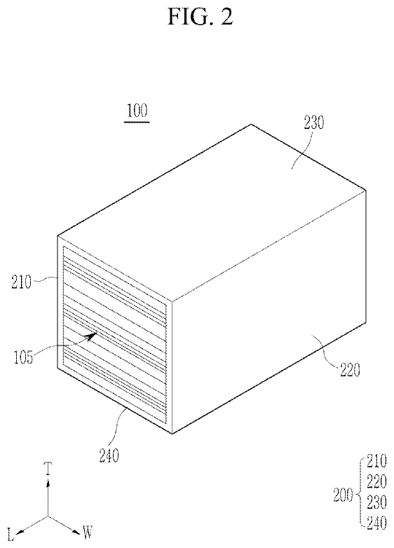

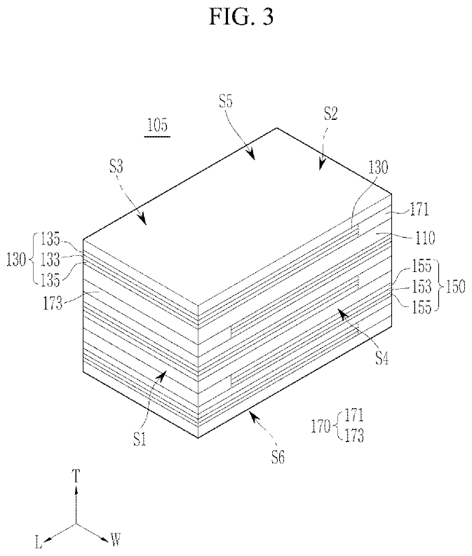

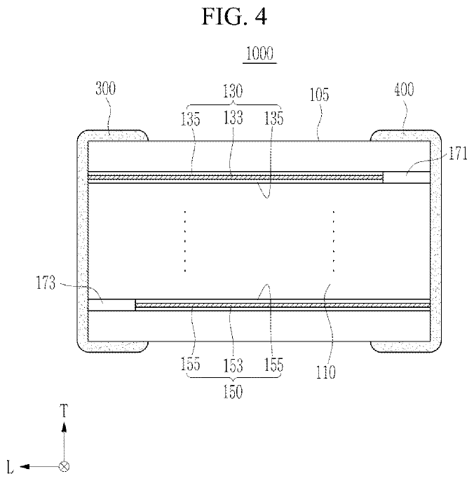

FIG. 1 is a perspective view schematically illustrating an all-solid-state battery according to an embodiment, and FIG. 2 is a perspective view schematically illustrating the main body of the all-solid battery of FIG. 1, and FIG. 3 is a perspective view schematically illustrating a laminate of the all-solid-state battery of FIG. 1, and FIG. 4 is a schematic cross-sectional view taken along line IV-IV′ in FIG. 1.

Referring to FIG. 1, FIG. 2, FIG. 3, and FIG. 4, an all-solid-state battery 1000 according to the present embodiment includes a main body 100, a first external electrode 300, and a second external electrode 400.

First, to clearly explain the present embodiment, directions will be defined. The L-axis, the W-axis, and the T-axis shown in the drawings refer to axes indicating the length direction, width direction, and thickness direction of the all-solid-state battery 1000, respectively.

The thickness direction (T-axis direction) may be a direction perpendicular to wide surfaces (main surfaces) of constituent elements having sheet shapes. For example, the thickness direction (T-axis direction) may be used as the same concept as the direction in which the constituent elements of a laminate 105 are stacked.

The length direction (L-axis direction) may be a direction parallel with wide surfaces (main surfaces) of constituent elements having sheet shapes, and be a direction that intersects (or is orthogonal to) the thickness direction (T-axis direction). For example, the length direction (L-axis direction) may be the direction in which the first external electrode 300 and the second external electrode 400 face each other.

The width direction (W-axis direction) may be a direction parallel with wide surfaces (main surfaces) of constituent elements having sheet shapes, and be a direction that intersects (is orthogonal to) both the thickness direction (T-axis direction) and the length direction (L-axis direction).

The main body 100 includes the laminate 105 and a margin member 200.

The laminate 105 may be formed in a roughly hexahedral shape, but the present embodiment is not limited thereto. Due to shrinkage during sintering, the laminate 105 may have a substantially hexahedral shape, although not a perfect hexahedral shape. For example, the laminate 105 may have a substantially cuboid shape having rounded edges or vertices.

In the present embodiment, for ease of explanation, surfaces facing each other in the length direction (L-axis direction) are defined as a first surface S1 and a second surface S2, and surfaces that face each other in the width direction (W-axis direction) and couple the first surface S1 and the second surface S2 are defined as a third surface S3 and a fourth surface S4, and surfaces that face each other in the thickness direction (T-axis direction) and couple the first surface S1 and the second surface S2 are defined as a fifth surface S5 and a sixth surface S6.

Accordingly, a first direction in which the first surface S1 and the second surface S2 face each other may be the length direction (L-axis direction), and a second direction and a third direction which are perpendicular to the first direction and are perpendicular to each other may be the thickness direction (T-axis direction) and the width direction (W-axis direction), respectively, or may be the width direction (W-axis direction) and the thickness direction (T-axis direction), respectively.

In an optical microscope photograph or SEM (Scanning Electron Microscope) photograph of the lengthwise (L-axis direction) and thickness-wise (T-axis direction) cross section of the laminate 105 at the center in the width direction (W-axis direction), the length of the laminate 105 may refer to the maximum of the lengths of a plurality of line segments, each of which connects two outermost boundary lines of the laminate 105 facing each other in the length direction (L-axis direction), shown in the above-mentioned cross sectional photograph, and is parallel with the length direction (L-axis direction). Alternatively, the length of the laminate 105 may refer to the minimum of the lengths of a plurality of line segments, each of which connects two outermost boundary lines of the laminate 105 facing each other in the length direction (L-axis direction), shown in the above-mentioned cross sectional photograph and is parallel with the length direction (L-axis direction). Or, the length of the laminate 105 may refer to the arithmetic average of the lengths of at least two line segments of a plurality of line segments, each of which connects two outermost boundary lines of the laminate 105 facing each other in the length direction (L-axis direction), shown in the above-mentioned cross sectional photograph and is parallel with the length direction (L-axis direction).

In an optical microscope photograph or SEM (Scanning Electron Microscope) photograph of the lengthwise (L-axis direction) and thickness-wise (T-axis direction) cross section of the laminate 105 at the center in the width direction (W-axis direction), the thickness of the laminate 105 may refer to the maximum of the lengths of a plurality of line segments, each of which connects two outermost boundary lines of the laminate 105 facing each other in the thickness direction (T-axis direction), shown in the above-mentioned cross sectional photograph, and is parallel with the thickness direction (T-axis direction). Alternatively, the thickness of the laminate 105 may refer to the minimum of the lengths of a plurality of line segments, each of which connects two outermost boundary lines of the laminate 105 facing each other in the thickness direction (T-axis direction), shown in the above-mentioned cross sectional photograph and is parallel with the thickness direction (T-axis direction). Or, the thickness of the laminate 105 may refer to the arithmetic average of the lengths of at least two line segments of a plurality of line segments, each of which connects two outermost boundary lines of the laminate 105 facing each other in the thickness direction (T-axis direction), shown in the above-mentioned cross sectional photograph and is parallel with the thickness direction (T-axis direction).

In an optical microscope photograph or SEM (Scanning Electron Microscope) photograph of the lengthwise (L-axis direction) and width-wise (W-axis direction) cross section of the laminate 105 at the center in the thickness direction (T-axis direction), the width of the laminate 105 may refer to the maximum of the lengths of a plurality of line segments, each of which connects two outermost boundary lines of the laminate 105 facing each other in the width direction (W-axis direction), shown in the above-mentioned cross sectional photograph, and is parallel with the width direction (W-axis direction). Alternatively, the width of the laminate 105 may refer to the minimum of the lengths of a plurality of line segments, each of which connects two outermost boundary lines of the laminate 105 facing each other in the width direction (W-axis direction), shown in the above-mentioned cross sectional photograph and is parallel with the width direction (W-axis direction). Or, the width of the laminate 105 may refer to the arithmetic average of the lengths of at least two line segments of a plurality of line segments, each of which connects two outermost boundary lines of the laminate 105 facing each other in the width direction (W-axis direction), shown in the above-mentioned cross sectional photograph and is parallel with the width direction (W-axis direction).

The laminate 105 may include solid electrolyte layers 110, anode layers 130, cathode layers 150, and insulators 170.

Each of the numbers of solid electrolyte layers 110, anode layers 130, and cathode layers 150 may be two or more, and the anode layers 130 and the cathode layers 150 may be alternately stacked in the thickness direction (T-axis direction) with the solid electrolyte layers 110 interposed therebetween.

On one surface of each solid electrolyte layer 110, an anode layer 130 may be disposed, and on the other surface of the corresponding solid electrolyte layer 110, a cathode layer 150 may be disposed.

The solid electrolyte layers 110 may contain a solid electrolyte. The solid electrolyte may serve as a passage for lithium (Li) ions.

The solid electrolyte which is contained in the solid electrolyte layers 110 may contain a glass-ceramic-based electrolyte containing lithium halide (LiX wherein X is a lithium halogen element such as F, Br, Cl, I, etc.). Glass-ceramic (or crystallized glass) refers to a crystallographic mixture of amorphous and crystalline materials from which peaks and halos are observed in X-ray diffraction, electron diffraction, etc. Accordingly, the glass-ceramic-based electrolyte is an electrolyte that has undergone partial crystallization through sintering and in which amorphous and crystalline materials are mixed.

The glass-ceramic-based electrolyte may be a mixture of an amorphous material and two or more types of crystalline materials. Further, the crystalline materials which are contained in the glass-ceramic-based electrolyte may include a lithium-compound crystalline phase containing lithium.

When the glass-ceramic-based electrolyte is contained, sufficient densification is achieved after sintering, whereby it is possible to realize high ionic conductivity.

The glass-ceramic-based electrolyte may contain lithium (Li) oxide, boron (B) oxide, silicon (Si) oxide, aluminum (Al) oxide, gallium (Ga) oxide, phosphorus (P) oxide, germanium (Ge) oxide, magnesium (Mg) oxide, and lithium chloride (LiCl). As a specific example, the glass-ceramic-based electrolyte may contain Li₂O—B₂O₃—SiO₂—P₂O₅—GeO₂—LiCl.

On the other hand, the solid electrolyte which is contained in the solid electrolyte layers 110 may contain a lithium-borosilicate-based electrolyte (hereinafter, also referred to as an LBSO-based electrolyte). The LBSO-based electrolyte is a glass-state electrolyte, and glass refers to a crystallographically amorphous material from which halos are observed in X-ray diffraction, electron diffraction, etc.

When the LBSO-based electrolyte is contained, it is possible to keep the amorphous state during sintering while lowering the sintering temperature. Therefore, there is an advantage that it is possible to realize high ionic conductivity and reactivity with electrodes is not high. The LBSO-based electrolyte may contain lithium (Li), boron (B), silicon (Si), aluminum (Al), phosphorus (P), germanium (Ge), and sulfur (S).

Alternatively, the solid electrolyte which is contained in the solid electrolyte layers 110 may be one or more types selected from a group consisting of a Garnet-type, a Nasicon-type, a LISICON-type, a perovskite-type, and a LiPON-type.

The Garnet-type solid electrolyte may refer to lithium lanthanum zirconium oxide (LLZO) represented by LiₐLa_{b}Zr_{c}O₁₂, such as Li₇La₃Zr₂O₁₂, and the Nasicon-type electrolyte may refer to lithium-aluminum-titanium-phosphate (LATP) Li₁₊ₓAlₓTi₂₋ₓ(PO₄)₃ (wherein 0<x<1) produced by introducing Ti into LAMP (Li₁₊ₓAlₓM₂₋ₓ(PO₄)₃ (wherein 0<x<2 and M is Zr, Ti, or Ge) type compound, lithium-aluminum-germanium-phosphate (LAGP) represented by Li₁₊ₓAlₓGe₂₋ₓ(PO₄)₃ (wherein 0<x<1), such as Li_{1.3}Al_{0.3}Ge_{1.7}(PO₄)₃ containing an excessive amount of lithium, and/or lithium-zirconium-phosphate (LZP) LiZr₂(PO₄)₃.

Further, the LISICON-type solid electrolyte may refer to solid solution oxide represented by xLi₃AO₄—(1−x)Li₄BO₄ (wherein A is P, As, V, etc., and B is Si, Ge, Ti, etc.), such as Li₄Zn(GeO₄)₄, Li₁₀GeP₂O₁₂(LGPO), Li_{3.5}Si_{0.5}P_{0.5}O₄, Li_{10.42}Si(Ge)_{1.5}P_{1.5}Cl_{0.08}O_{11.92}, etc., and solid solution sulfide represented by Li₄₋ₓM_{1-y}M′_{y}S₄ (wherein M is Si or Ge and M′ is P, Al, Zn, or Ga), such as Li₂S—P₂S₅, Li₂S—SiS₂, Li₂S—SiS₂—P₂S₅, Li₂S—GeS₂, etc.

Furthermore, the perovskite-type solid electrolyte may refer to lithium lanthanum titanate (LLTO) represented by Li₃ₓLa_{2/3-x□1/3-2x}TiO₃ (wherein 0<x<0.16, and □ is an assumed vacancy content), such as Li_{1/8}La_{5/8}TiO₃, and the LiPON-type solid electrolyte may refer to nitride like lithium phosphorous oxynitride such as Li_{2.8}PO_{3.3}N_{0.46}, etc.

The anode layers 130 may be exposed from the first surface S1 of the laminate 105, and be coupled to the first external electrode 300.

The anode layers 130 may include anode current collector 133 and anode active material layers 135.

The anode current collectors 133 may be formed of, for example, plate-like members or thin members. As another example, the anode current collectors 133 may be porous members having a reticular shape, a mesh shape, etc.

The anode current collectors 133 may be porous metal plates made of, for example, stainless steel, nickel (Ni), copper (Cu), tin (Sn), aluminum (Al), or an alloy thereof, but are not limited thereto.

Further, the anode current collectors 133 may also be coated with oxidation-resistant metal or alloy films to prevent oxidation.

The anode active material layers 135 may contain an anode active material, and be disposed on the surfaces of the anode current collectors 133. The anode active material layers 135 may be formed by performing printing on one surface or both surfaces of each anode current collector 133 with the anode active material, but the method of forming the anode active material layers is not limited thereto.

The anode active material which is contained in the anode active material layers 135 may be a material containing lithium (Li) ions. The anode active material may reversibly intercalate deintercalate lithium ion. In other words, the anode active material may contain lithium ions and serve to provide lithium ions to the cathode when the all-solid-state battery is being charged. The anode active material may affect the capacity and output of the all-solid-state battery.

The anode active material may be, for example, compounds represented by the following chemical formulae: LiₐA_{I-b}M_{b}D₂ (wherein 0.90≤a≤1.8 and 0≤b≤0.5); LiₐE_{I-b}M_{b}O_{2-c}D_{c} (wherein 0.90≤a≤1.8, 0≤b≤0.5, and 0≤c≤0.05); LiE_{2-b}M_{b}O_{4-c}D_{c} (wherein 0≤b≤0.5 and 0≤c≤0.05); LiₐNi_{1-b-c}Co_{b}M_{c}D_{α} (wherein 0.90≤a≤1.8, 0≤b≤0.5, 0≤c≤0.05, and 0<α≤2); LiₐNi_{1-b-c}Co_{b}M_{c}O_{2-α}X_{α} (wherein 0.90≤a≤1.8, 0≤b≤0.5, 0≤c≤0.05, and 0<α<2); LiₐNi_{1-b-c}Co_{b}M_{c}O_{2-α}X₂ (wherein 0.90≤a≤1.8, 0≤b≤0.5, 0≤c≤0.05, and 0<α<2); LiₐNi_{1-b-c}Mn_{b}M_{c}D_{α} (wherein 0.90≤a≤1.8, 0≤b≤0.5, 0≤c≤0.05, and 0<α≤2); LiₐNi_{1-b-c}Mn_{b}M_{c}O_{2-α}X_{α} (wherein 0.90≤a≤1.8, 0≤b≤0.5, 0≤c≤0.05, and 0<α<2); LiₐNi_{1-b-c}Mn_{b}M_{c}O₂₋ₐX₂ (wherein 0.90≤a≤1.8, 0≤b≤0.5, 0≤c≤0.05, and 0<α<2); LiₐNi_{b}E_{c}G_{d}O₂ (wherein 0.90≤a≤1.8, 0≤b≤0.9, 0≤c≤0.5, and 0.001≤d≤0.1); LiₐNi_{b}Co_{c}MnₐGₑO₂ (wherein 0.90≤a≤1.8, 0≤b≤0.9, 0≤c≤0.5, 0≤d≤0.5, and 0.001≤e≤0.1); LiₐNiG_{b}O₂ (wherein 0.90≤a≤1.8 and 0.001≤b≤0.1); LiₐCoG_{b}O₂ (wherein 0.90≤a≤1.8 and 0.001≤b≤0.1); LiₐMnG_{b}O₂ (wherein 0.90≤a≤1.8 and 0.001≤b≤0.1); LiₐMn₂G_{b}O₄ (wherein 0.90≤a≤1.8 and 0.001≤b≤0.1); QO₂; QS₂; LiQS₂; V₂O₅; LiV₂O₂; LiRO₂; LiNIVO₄; Li_{(3-f)}J₂(PO₄)₃ (0≤f≤2); Li_{(3-f)}Fe₂(PO₄)₃ (wherein 0≤f≤2); and LiFePO₄. In the above-mentioned chemical formulae, A is Ni, Co, or Mn, and M is Al, Ni, Co, Mn, Cr, Fe, Mg, Sr, V, or a rare-earth element, and D is O, F, S, or P, and E is Co or Mn, and X is F, S, or P, and G is Al, Cr, Mn, Fe, Mg, La, Ce, Sr, or V, and Q is Ti, Mo or Mn, and R is Cr, V, Fe, Sc, or Y, and J is V, Cr, Mn, Co, Ni, or Cu.

Also, the anode active material may be LiCoO₂, LiMnₓO₂ₓ (wherein x is 1 or 2), LiNi₁₋ₓMnₓO₂ₓ (wherein 0<x<1), LiNi_{1-x-y}COₓMn_{y}O₂ (wherein 0≤x≤0.5 and 0≤y≤0.5), LiFePO₄, TiS₂, FeS₂, TiS₃, or FeS₃, but is not limited thereto.

The anode active material may optionally contain a conductive material and a binder.

The conductive material is not particularly limited as long as it has conductivity without causing any chemical change in the all-solid-state battery 1000. For example, graphite such as natural graphite or artificial graphite, carbon-based materials such as carbon black, acetylene black, Ketjen black, channel black, furnace black, lamp black, and thermal black, conductive fibers such as carbon fibers, metal fibers, etc., carbon fluoride, metal components such as lithium (Li), tin (Sn), aluminum (Al), nickel (Ni), copper (Cu), etc., oxides, nitrides, or fluorides of the metal components, conductive whiskers such as zinc oxide and potassium titanate, conductive metal oxides such as titanium oxide, conductive materials such as polyphenylene derivatives, etc., and so on may be used.

The binder may be used to improve the bonding force of the active material, the conductive material, etc. Examples of the binder may include polyvinylidene fluoride, polyvinyl alcohol, carboxymethylcellulose (CMC), starch, hydroxypropylcellulose, regenerated cellulose, polyvinylpyrrolidone, polytetrafluoroethylene, polyethylene, polypropylene, ethylene-propylene-diene terpolymers (EPDMs), sulfonated EPDMs, styrene butadiene rubbers, fluoro-rubbers, various copolymers, etc., but is not limited thereto.

Further, the anode layers 130 may further contain a solid electrolyte component. The solid electrolyte component may contain one or more components among the above-mentioned components, and may serve as ion conduction channels in the anode layers. Accordingly, it is possible to reduce the interface resistance.

The cathode layers 150 may be exposed from the second surface S2 of the laminate 105, and may be coupled to the second external electrode 400.

The cathode layers 150 may include cathode current collectors 153 and cathode active material layers 155.

The cathode current collectors 153 may be formed of, for example, plate- like members or thin members. As another example, the cathode current collectors 153 may be formed of porous members having a reticular shape, a mesh shape, etc.

The cathode current collectors 153 may be porous metal plates made of, for example, stainless steel, nickel (Ni), copper (Cu), tin (Sn), aluminum (Al), or an alloy thereof, but are not limited thereto.

Further, the cathode current collectors 153 may also be coated with oxidation-resistant metal or alloy films to prevent oxidation.

The cathode active material layers 155 may contain a cathode active material, and be disposed on the surfaces of the cathode current collectors 153. The cathode active material layers 155 may be formed by performing printing on one surface or both surfaces of each cathode current collector 153 with the cathode active material, but the method of forming the cathode active material layers is not limited thereto.

The cathode active material which is contained in the cathode active material layers 155 may generate electrical energy by storing lithium ions coming from the anode during discharging of the all-solid-state battery and releasing the lithium ions. As the cathode active material, a carbon-based material, silicon, a silicon oxide, a silicon-based alloy, a silicon-carbon-based material composite, tin, a tin-based alloy, a tin-carbon composite, a metal oxide, or a combination thereof may be used, and the cathode active material may contain a lithium metal and/or a lithium metal alloy.

The lithium metal alloy may contain lithium, and a metal/metalloid capable of making an alloy with lithium. For example, the metal/metalloid capable of making an alloy with lithium may be Si, Sn, Al, Ge, Pb, Bi, Sb, Si-AM alloys (wherein AM is an alkali metal, an alkaline earth metal, an element in group 13 to group 16, a transition metal, a rare earth element, or a combination thereof, and does not include Si), a Sn-AM alloy (wherein AM is an alkali metal, an alkaline earth metal, an element in group 13 to group 16, a transition metal, a transition metal oxide such as lithium titanium oxide (Li₄Ti₅O₁₂), a rare earth element, or a combination thereof, and does not include Sn), MnOₓ (wherein 0<x≤2), etc.

The element AM may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, or a combination thereof.

Further, oxides of the metal/metalloid capable of making an alloy with lithium may be lithium titanium oxide, vanadium oxide, lithium vanadium oxide, SnO₂, SiOₓ (wherein 0<x<2), etc. For example, the cathode active material may contain one or more elements selected from a group consisting of the elements in group 13 to group 16 of the periodic table of the elements. For example, the cathode active material may contain one or more elements selected from a group consisting of Si, Ge, and Sn.

The carbon-based material may be crystalline carbon, amorphous carbon, or a mixture thereof. The crystalline carbon may be graphite such as natural graphite or artificial graphite that is in a shapeless, disk-shaped, flaked, globular or fibrous form. Further, the amorphous carbon may be soft carbon (low-temperature sintered carbon), hard carbon, mesophase pitch carbide, sintered cokes, graphene, carbon black, fullerene soot, carbon nanotubes, carbon fiber, etc., but is not limited thereto.

The silicon may be a material selected from a group consisting of Si, SiOₓ (wherein 0<x<2, for example, 0.5 to 1.5), Sn, SnO₂, Si-containing metal alloys, and mixtures thereof. The Si-containing metal alloys may contain, for example, silicon, and one or more of Al, Sn, Ag, Fe, Bi, Mg, Zn, in, Ge, Pb, and Ti.

The cathode active material may optionally contain a conductive material and a binder.

The conductive material is not particularly limited as long as it has conductivity without causing any chemical change in the all-solid-state battery 1000. For example, graphite such as natural graphite or artificial graphite, carbon-based materials such as carbon black, acetylene black, Ketjen black, channel black, furnace black, lamp black, and thermal black, conductive fibers such as carbon fibers, metal fibers, etc., carbon fluoride, metal components such as lithium (Li), tin (Sn), aluminum (Al), nickel (Ni), copper (Cu), etc., oxides, nitrides, or fluorides of the metal components, conductive whiskers such as zinc oxide and potassium titanate, conductive metal oxides such as titanium oxide, conductive materials such as polyphenylene derivatives, etc., and so on may be used.

The binder may be used to improve the bonding force of the active material, the conductive material, etc. Examples of the binder may include polyvinylidene fluoride, polyvinyl alcohol, carboxymethylcellulose (CMC), starch, hydroxypropylcellulose, regenerated cellulose, polyvinylpyrrolidone, polytetrafluoroethylene, polyethylene, polypropylene, ethylene-propylene-diene terpolymers (EPDMs), sulfonated EPDMs, styrene butadiene rubbers, fluoro-rubbers, various copolymers, etc., but is not limited thereto.

The insulators 170 may include first insulators 171 and second insulators 173.

The first insulators 171 may be disposed so as to abut ends of the anode layers 130 in the length direction (L-axis direction) and be exposed from the second surface S2 of the laminate 105. The first insulators 171 may abut the solid electrolyte layers 110, similar to the anode layers 130. In other words, the first insulators 171 may be disposed on the same planes with the anode layers 130, thereby preventing structural defects from being caused by steps in the thickness direction (T-axis direction) of the laminate 105.

The second insulators 173 may be disposed so as to abut ends of the cathode layers 150 in the length direction (L-axis direction) and be exposed from the first surface S1 of the laminate 105. The second insulators 173 may abut the solid electrolyte layers 110, similar to the cathode layers 150. In other words, the second insulators 173 may be disposed on the same planes with the cathode layers 150, thereby preventing structural defects from being caused by steps in the thickness direction (T-axis direction) of the laminate 105.

The insulators 170 may contain a ceramic material, and may contain, for example, alumina (Al₂O₃), aluminum nitride (AlN), beryllium oxide (BeO), boron nitride (BN), silicon (Si), silicon carbide (SiC), silica (SiO₂), silicon nitride (Si₃N₄), gallium arsenide (GaAs), gallium nitride (GaN), barium titanate (BaTiO₃), zirconium dioxide (ZrO₂), a mixture thereof, an oxide and/or nitride of these materials, or any other suitable ceramic material, but is not limited thereto. Also, the insulators may optionally contain the above-mentioned solid electrolytes, and may contain one or more types of solid electrolytes, but is not limited thereto.

The margin member 200 may be disposed on the outer surface of the laminate 105 to prevent moisture penetration and prevent damage from being caused by physical and chemical impacts.

The margin member 200 may be disposed on the third surface S3, the fourth surface S4, the fifth surface S5, and the sixth surface S6 of the laminate 105.

In other words, the margin member 200 may include a first margin part 210 that is disposed on the third surface S3 of the laminate 105, a second margin part 220 that is disposed on the fourth surface S4 of the laminate 105, a third margin part 230 that is disposed on the fifth surface S5 of the laminate 105, and a fourth margin part 240 that is disposed on the sixth surface S6 of the laminate 105.

The margin member 200 may comprise an insulating material, that is, a material having no electronic (ionic) conductivity.

The margin member 200 may contain a ceramic material, and may contain, for example, alumina (Al₂O₃), aluminum nitride (AlN), beryllium oxide (BeO), boron nitride (BN), silicon (Si), silicon carbide (SiC), silica (SiO₂), silicon nitride (Si₃N₄), gallium arsenide (GaAs), gallium nitride (GaN), barium titanate (BaTiO₃), zirconium dioxide (ZrO₂), a mixture thereof, an oxide and/or nitride of these materials, or any other suitable ceramic material, but is not limited thereto.

Also, the margin member 200 may optionally contain the above-mentioned solid electrolytes, and may contain one or more types of solid electrolytes, but is not limited thereto.

In the margin member 200, a material having low ionic conductivity and low electrical conductivity, i.e., an insulating material may be present, and a material having ionic conductivity (or electrical conductivity) similar to the ionic conductivity (or electrical conductivity) of the solid electrolyte may be present. For example, when a material having ionic conductivity (or electrical conductivity) similar to the ionic conductivity (or electrical conductivity) of the solid electrolyte is present in the margin member, that material may be a material identical to or different from the solid electrolyte in other regions. As another example, a material having ionic conductivity (or electrical conductivity) similar to the ionic conductivity (or electrical conductivity) of the solid electrolyte and an insulating material may coexist in the margin member.

The margin member 200 may be disposed on the surface of the laminate 105 after the laminate 105 is formed. In other words, after the laminate 105 formed by alternately stacking the anode layers 130 and the cathode layers 150 in the thickness direction (T-axis direction) with the solid electrolyte layers 110 interposed therebetween is sintered, the margin member 200 may be disposed on the third surface S3, the fourth surface S4, the fifth surface S5, and the sixth surface S6 of the laminate 105.

Before the margin member 200 is disposed, the solid electrolyte layers 110, the anode layers 130, the cathode layers 150 of the laminate 105 may be exposed from the third surface S3 and the fourth surface S4 of the laminate 105. Since the margin member 200 is disposed, the solid electrolyte layers 110, the anode layers 130, and the cathode layers 150 abut the margin member 200 on the third surface S3 and the fourth surface S4 of the laminate 105. In other words, on the third surface S3 of the laminate 105, the solid electrolyte layers 110, the anode layers 130, and the cathode layers 150 abut the first margin part 210, and on the fourth surface S4 of the laminate 105, the solid electrolyte layers 110, the anode layers 130, and the cathode layers 150 abut the second margin part 220.

On the other hand, depending on the numbers and arrangements of solid electrolyte layers 110, anode layers 130, and cathode layers 150, the solid electrolyte layers 110 may be exposed from the fifth surface S5 and the sixth surface S6 of the laminate 105, and the anode layers 130 or the cathode layers 150 may be exposed from the fifth surface S5 and the sixth surface S6 of the laminate 105. Accordingly, on the fifth surface S5 of the laminate 105, the solid electrolyte layers 110, and either the anode layers 130 or the cathode layers 150 may abut the third margin part 230, and on the sixth surface S6 of the laminate 105, solid electrolyte layers 110, and either the anode layers 130 or the cathode layers 150 may abut the fourth margin part 240.

The margin member 200 may be made by various methods. For example, the margin member may be made by depositing or impregnating the above-mentioned ceramic material on the third surface S3, the fourth surface S4, the fifth surface S5, and the sixth surface S6 of the laminate 105. As another example, the margin member may be made by applying slurry containing the above-mentioned ceramic material to the third surface S3, the fourth surface S4, the fifth surface S5, and the sixth surface S6 of the laminate 105, or the margin member may be made by attaching sheets made of the above-mentioned ceramic material to the third surface S3, the fourth surface S4, the fifth surface S5, and the sixth surface S6 of the laminate 105.

The margin member 200 may be disposed on the laminate 105, thereby forming the main body 100 of the all-solid-state battery 1000. Since the laminate 105 includes the solid electrolyte layers 110, the anode layers 130, and the cathode layers 150, it contributes to the capacity of the all-solid-state battery 1000, but the margin member 200 does not contribute to the capacity of the all-solid-state battery 1000. Therefore, when the volume of the main body is constant, as the volume of the margin member decreases, the capacity of the all-solid-state battery may increase.

According to the present embodiment, since the margin member is formed so as to have a relatively small volume and the laminate is formed so as to have a relatively large volume, the all-solid-state battery can have a larger capacity with the same volume.

The first external electrode 300 and the second external electrode 400 may be disposed outside the main body 100, and be coupled to the laminate 105.

The first external electrode 300 is coupled to the anode layers 130 on the first surface S1 of the laminate 105.

For example, the first external electrode 300 may extend to the third surface S3, the fourth surface S4, the fifth surface S5, and the sixth surface S6 of the laminate 105 so as to partially cover the individual margin parts 210, 220, 230, and 240.

The second external electrode 400 may be coupled to the cathode layers 150 on the second surface S2 of the laminate 105. The second external electrode 400 may extend to the third surface S3, the fourth surface S4, the fifth surface S5, and the sixth surface S6 of the laminate 105 so as to partially cover the individual margin parts 210, 220, 230, and 240.

On the other hand, in another embodiment, the first external electrode 300 and the second external electrode 400 may extend to any one surface of the fifth surface S5 and the sixth surface S6 so as to partially cover the margin part of the corresponding surface.

For example, the first external electrode 300 and the second external electrode 400 may be made by applying paste for terminal electrodes containing a conductive metal to each of the first surface S1 and the second surface S2 of the laminate 105, and may be made by transferring dry films produced by drying conductive paste to the laminate 105 and sintering it; however, the method of forming the first and second external electrodes 300 and 400 is not limited thereto. On the other hand, the conductive metal may be, for example, one or more of copper (Cu), nickel (Ni), tin (Sn), palladium (Pd), platinum (Pt), gold (Au), silver (Ag), tungsten (W), titanium (Ti), lead (Pb), and alloys thereof, but is not limited thereto.

Each of the first external electrode 300 and the second external electrode 400 may be covered with a plating layer (not shown in the drawings). The plating layer may contain one or more selected from a group consisting of copper (Cu), nickel (Ni), tin (Sn), palladium (Pd), platinum (Pt), gold (Au), silver (Ag), tungsten (W), titanium (Ti), lead (Pb), and alloys thereof, but is not limited thereto. The plating layer may be formed of one or more layers.

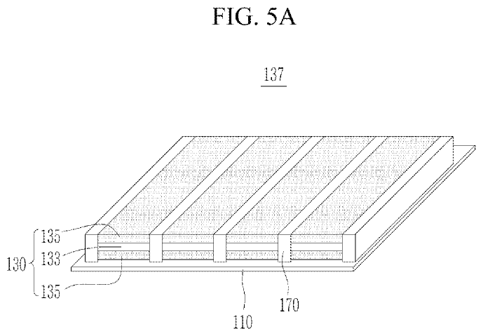

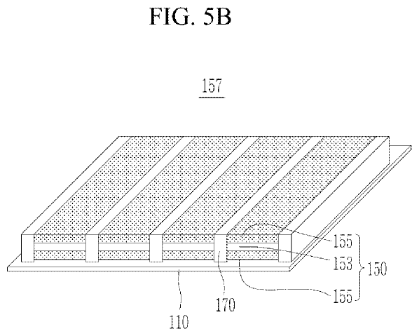

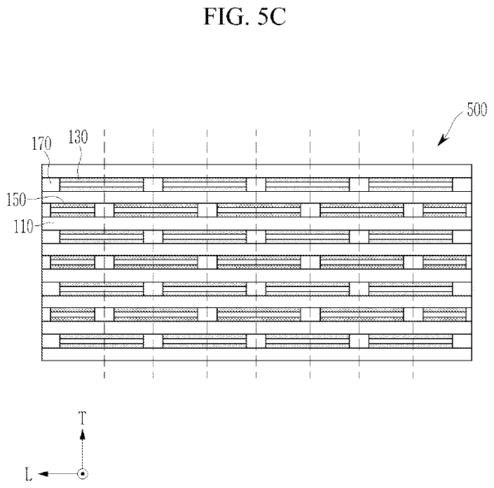

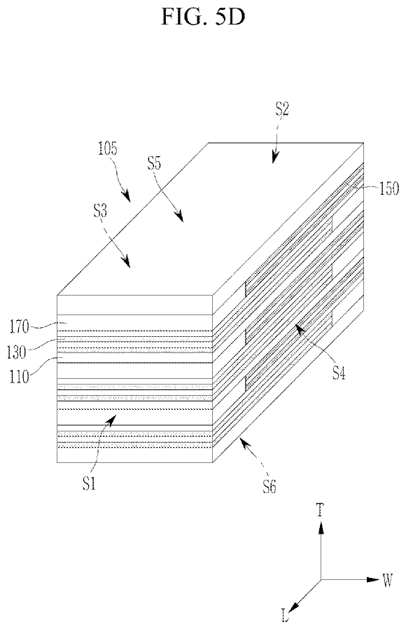

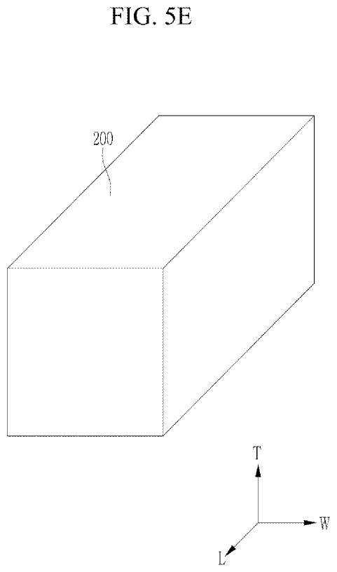

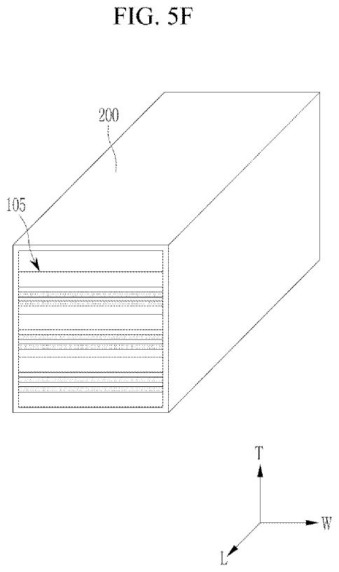

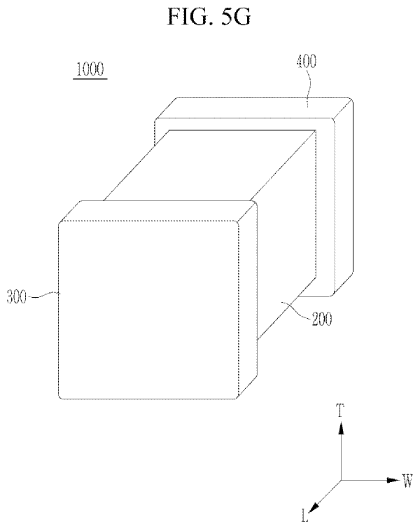

Hereinafter, a method of manufacturing the all-solid-state battery according to an embodiment will be described with reference to FIG. 5A to FIG. 5G. FIG. 5A to FIG. 5G are views schematically illustrating a method of manufacturing the all-solid-state battery according to an embodiment.

As shown in FIG. 5A, on a solid electrolyte layer (a green sheet) 110, a plurality of stripe-like anode layers 130 is formed by performing printing in the order of an anode active material layer 135, an anode current collector 133, and another anode active material layer 135, and the spaces between the anode layers are filled with insulators 170. In this way, anode sheets 137 are formed.

As shown in FIG. 5B, on a solid electrolyte layer (a green sheet) 110, a plurality of stripe-like cathode layers 150 is formed by performing printing in the order of a cathode active material layer 155, a cathode current collector 153, and another cathode active material layer 155, and the spaces between the cathode layers are filled with insulators 170. In this way, cathode sheets 157 are formed.

As shown in FIG. 5C, the anode sheets 137 and the cathode sheets 157 are alternately stacked, whereby a green chip 500 is formed.

The green chip 500 is cut along cutting lines (dotted lines in FIG. 5C) such that the solid electrolyte layers 110, the anode layers 130, the cathode layers 150, and the insulators 170 are exposed from surfaces except for two surfaces facing each other in the stacking direction (T-axis direction), whereby a laminate 105 is formed as shown in FIG. 5D.

The laminate 105 is sintered at a temperature of 400° C. or more and 550° C. or less in an air or nitrogen atmosphere.

As shown in FIG. 5E, on the surface of the sintered laminate 105, a margin member 200 is disposed.

Polishing (etching or sandblasting) is performed on the width-wise (W-axis direction) and thickness-wise (T-axis direction) surfaces of the laminate 105, such that the margin member 200 is removed.

As shown in FIG. 5G, to the width-wise (W-axis direction) and thickness-wise (T-axis direction) surfaces of the laminate 105 from which the margin member has been removed, conductive paste is applied, whereby a first external electrode 300 and a second external electrode 400 are formed. In this way, an all-solid-state battery 1000 is manufactured.

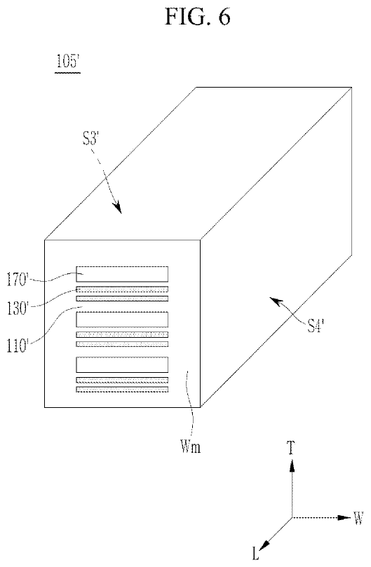

Meanwhile, FIG. 6 is a view schematically illustrating a laminate manufactured by an all-solid-state manufacturing method according to a comparative example.

Referring to FIG. 6, a laminate 105′ is formed such that margin regions Wm are formed in the width direction (W-axis direction) of the laminate 105′. Accordingly, solid electrolyte layers 110′, anode layers 130′, cathode layers (not shown in the drawing), insulators 170′, and so on are not exposed from a third surface S3′ and a fourth surface S4′ of the laminate 105′.

In contrast, referring to FIG. 5D, in the width direction (W-axis direction) of the laminate 105, a margin region is not formed. Accordingly, from the third surface S3 and the fourth surface S4 of the laminate 105, the solid electrolyte layers 110, the anode layers 130, the cathode layers 150, the insulator 170, and so on are exposed.

While any width-wise (W-axis direction) margin region is not formed in the laminate 105 shown in FIG. 5D, in the laminate 105′ shown in FIG. 6, the margin regions Wm are formed in the width direction (W-axis direction). Therefore, even if the volumes of the two laminates are the same, the volume of the part of the laminate 105 shown in FIG. 5D in which the solid electrolyte layers 110, the anode layers 130, and the cathode layers 150 are stacked may be larger, and the capacity of the all-solid-state battery including the laminate 105 may be correspondingly higher.

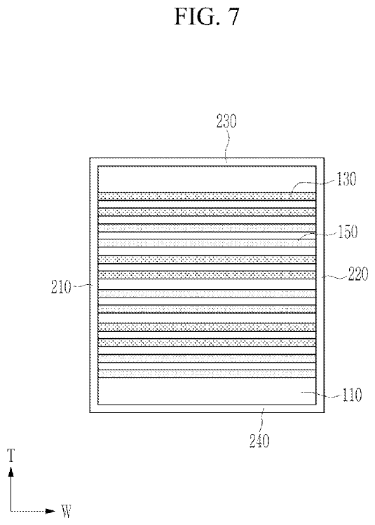

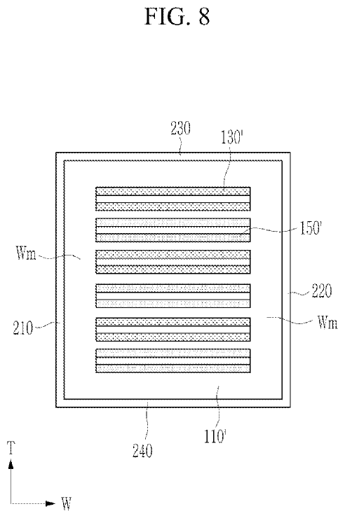

FIG. 7 is a width-wise (W-axis direction) and thickness-wise (T-axis direction) cross section of the all-solid-state battery, manufactured according to the embodiment, at the center in the length-wise (L-axis direction), and FIG. 8 is a width-wise (W-axis direction) and thickness-wise (T-axis direction) cross section of the all-solid-state battery, manufactured according to the comparative example, at the center in the length-wise (L-axis direction).

The volumes of the main bodies of the all-solid-state batteries manufactured in the embodiment and the comparative example, the margins in the main bodies, and the thicknesses of the insulating materials, and the volumes of the laminates were measured, and the results are shown in Table 1.

TABLE 1

| | | | Com- |
|---|---|---|---|
| | | Embod- | parative |
| | | iment | Example |
| Main Body | Length (mm) | 10 | 10 |
| | Width (mm) | 10 | 10 |
| | Thickness (mm) | 10 | 10 |
| | Volume (mm³) | 1000 | 1000 |
| Margin Region | Length Direction Margin (mm) | 1.2 | 1.2 |
| in Main Body | Width Direction Margin (mm) | 0 | 1.2 |
| | Thickness Direction Margin (mm) | 0.7 | 0.7 |
| Margin | Length Direction Thickness (mm) | 0 | 0 |
| Member | Width Direction Thickness (mm) | 0.2 | 0.2 |
| | Thickness Direction | 0.2 | 0.2 |
| | Thickness (mm) | | |
| Laminate | Volume (mm³) | 784.784 | 688.688 |

| | | |
|---|---|---|
| Ratio of Laminate Volume to Main | about 78.5 | about 68.9 |
| Body Volume (%) | | |

The volume of the laminate according to the embodiment is the product of values obtained by subtracting the sizes of the margin regions in the main body and the margin member from the length, width, and thickness of the main body. In other words, the volume of the laminate is the product of 8.8 mm (=10 mm-1.2 mm), 9.8 mm (=10 mm-0.2 mm), and 9.1 mm (=10 mm-0.9 mm), i.e., 784.784 mm³.

The volume of the laminate according to the comparative example may be obtained in the same manner as that in the embodiment. In other words, the volume of the laminate is the product of 8.8 mm (=10 mm-1.2 mm), 8.6 mm (=10 mm-1.4 mm), and 9.1 mm (=10 mm-0.9 mm), i.e., 688.688 mm³.

Referring to Table 1, it can be confirmed that the volume of the laminate of the all-solid-state battery according to the embodiment is about 78.5% of the volume of the main body, and the volume of the laminate of the all-solid-state battery according to the comparative example is about 68.9% of the volume of the main body. In other words, although the volumes of the main bodies of the all-solid-state battery according to the embodiment and the all-solid-state battery according to the comparative example are the same, since the margin region in the main body of the all-solid-state battery according to the embodiment has no width-wise margin, the volume of the laminate of the embodiment is larger than the volume of the laminate of the comparative example. As a result, the capacity of the all-solid-state battery according to the embodiment may be higher than the capacity of the all-solid-state battery according to the comparative example.

While this invention has been described in connection with what is presently considered to be practical embodiments, it is to be understood that the invention is not limited to the disclosed embodiments. On the contrary, it is intended to cover various modifications and equivalent arrangements included within the spirit and scope of the appended claims.

### DESCRIPTION OF SYMBOLS

1000: All-solid-state battery
100: Main body
105, 105′: Laminate
110, 110′: Solid electrolyte layer
130, 130′: Anode layer
133: Anode current collector
135: Anode active material layer
137: Anode sheet
150, 150′: Cathode layer
153: Cathode current collector
155: Cathode active material layer
157: Cathode sheet
170, 170′: Insulator
171: First insulator
173: Second insulator
200: Margin member
210: First margin part
220: Second margin part
230: Third margin part
240: Fourth margin part
300: First external electrode
400: Second external electrode
500: Green chip
Wm: Margin region

1. An all-solid-state battery comprising:
a laminate that has a first surface and a second surface facing each other in a first direction, a third surface and a fourth surface face each other in a second direction and coupling the first surface and the second surface, and a fifth surface and a sixth surface facing each other in a third direction and coupling the first surface and the second surface, and includes solid electrolyte layers, and anode layers and cathode layers that are alternately stacked in the third direction with the solid electrolyte layers interposed therebetween; and
a margin member that is disposed on the third surface, the fourth surface, the fifth surface, and the sixth surface of the laminate.

2. The all-solid-state battery of claim 1, wherein
the margin member comprises an insulating material.

3. The all-solid-state battery of claim 1, wherein
the solid electrolyte layers, the anode layers, and the cathode layers abut the margin member on the third surface and the fourth surface of the laminate.

4. The all-solid-state battery of claim 3, further comprising:
a first external electrode that is coupled to the anode layers on the first surface of the laminate; and
a second external electrode that is coupled to the cathode layers on the second surface of the laminate.

5. The all-solid-state battery of claim 4, further comprising:
first insulators that are disposed between the second surface of the laminate and the anode layers; and
second insulators that are disposed between the first surface of the laminate and the cathode layers.

6. The all-solid-state battery of claim 5, wherein
the first insulators abut the solid electrolyte layers, and the second insulators abut the solid electrolyte layers.

7. The all-solid-state battery of claim 6, wherein
the first insulators and the second insulators comprise the same material as that of the margin member.

8. The all-solid-state battery of claim 6, wherein
the first insulators and the second insulators comprise a material different from that of the margin member.

9. The all-solid-state battery of claim 4, wherein
the first external electrode extends to the third surface, the fourth surface, the fifth surface, and the sixth surface of the laminate so as to partially cover the margin member, and
the second external electrode extends to the third surface, the fourth surface, the fifth surface, and the sixth surface of the laminate so as to partially cover the margin member.

10. The all-solid-state battery of claim 4, wherein
the first external electrode extends to the fifth surface of the laminate so as to partially cover the margin member, and
the second external electrode extends to the fifth surface of the laminate so as to partially cover the margin member.

11. The all-solid-state battery of claim 1, wherein
the anode layers include anode current collectors and an anode active material, and
the cathode layers include cathode current collectors and a cathode active material.

12. The all-solid-state battery of claim 1, wherein
the margin member includes a ceramic material.

13. The all-solid-state battery of claim 1, wherein
the margin member includes one or more of alumina (Al₂O₃), aluminum nitride (AlN), beryllium oxide (BeO), boron nitride (BN), silicon (Si), silicon carbide (SiC), silica (SiO₂), silicon nitride (Si₃N₄), gallium arsenide (GaAs), gallium nitride (GaN), barium titanate (BaTiO₃), or zirconium dioxide (ZrO₂).

14. The all-solid-state battery of claim 1, wherein
the margin member includes one continuous layer extending on the third surface, the fifth surface, the fourth surface, and the sixth surface of the laminate.

15. The all-solid-state battery of claim 1, wherein
the margin member is in contact with the anode layers and the cathode layers.

16. The all-solid-state battery of claim 1, wherein
the margin member includes a material different from the solid electrolyte layers.
